(19) United States
(12) Patent Application Publication
(10) Pub. No.: US 2003/0061312 A1
(43) Pub. Date: Mar. 27, 2003

(54) Reduction of configuration time upon deployment of a configurable device in a shared resource environment

(76) Inventors: James T. Bodner, Houston, TX (US); Andrew Brown, Houston, TX (US)

Correspondence Address: CONLEY ROSE, P.C., P. O. BOX 3267, HOUSTON, TX, 77253-3267, US

(21) Appl. No.: 09/964,307

(22) Filed: Sep. 26, 2001

(51) Int. Cl. G06F 15/177

(52) U.S. Cl. 709/220

(57) ABSTRACT

A computer rack system includes a plurality of chassis of servers and power supplies and other equipment, as desired, mated to the rack. Each server chassis can accommodate a plurality of servers. The various servers located in a chassis couple to a chassis communication module and the various server chassis couple together via the chassis communication modules. Each server is initially configured when installed into the rack. When a server is activated, logic in the server determines whether the server has been configured. If the server has not been configured, the server submits a request to its chassis communication module. The request includes an indication as to the type of server being configured. The chassis communication module then determines whether another server of the same type in the rack has been configured. If such a server exists, that server's configuration is provided to the server being configured.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to a system of configurable devices. More particularly, the invention relates to a plurality of server computers (or other types of electronic, configurable devices) that are coupled together and can automatically be configured.

2. Background of the Invention

Many server computers are deployed in a rack environment. In this environment, a rack structure is equipped to receive one or more servers, power supplies, disk drives, network switches, and the like. For sake of convenience to the end user, in some racks the electrical equipment (servers, etc.) are fabricated to be inserted into a chassis that can easily be mated with the rack. The device chassis might be, for example, a metal enclosure that includes blind mating electrical connectors that, when the chassis is inserted into the rack, mate with corresponding connectors within the rack. If desired, however, the chassis without servers or other devices can be inserted into the rack. Then, as desired, servers can be slid into the chassis which is now part of the rack. Fabricated in this manner, a multitude of servers, power supplies and other devices can be slid into a rack.

This type of server rack system facilitates initially deploying the electrical equipment into the rack, as well as replacing the equipment. When a server, for example, is added to a rack or when an existing server is removed and replaced with another server (either because the existing server has malfunctioned or the operator wishes to upgrade an older model computer with an improved performance computer), the newly inserted server typically must be configured. Configuration may be necessary before the server can begin full operation. Conventionally, configuring a server, or other replaceable rack mounted equipment, entailed a person accessing an input control device or workstation coupled to the server and manually setting one or more configuration parameters. Such parameters might include the time of day, date, whether a power on password feature should be enabled, the language (e.g., English, German) for the user interface, etc. It is not uncommon for there to be dozens or even one hundred or so such parameters to configure for a single server computer. With an operator having to individually set this many parameters, it should be apparent that the conventional configuration process can be undesirably long and thus inconvenient to the end user.

Early on during the development of server rack systems, given the size and power demands for each server, each rack only contained four or five servers. Configuring four or five servers in a rack was time consuming, but generally within the realm of tolerability for an operator. With constant advances in miniaturization, servers have decreased in size generally without sacrificing performance. Today, it is not uncommon for server racks to include 20 or more servers. The number of servers that can be plugged into a rack has increased to the point where the configuration process has become virtually intolerable for many computer operators. Accordingly, an improvement is needed to somehow expedite the configuration process for the servers and other configurable equipment in a computer rack.

### BRIEF SUMMARY OF THE INVENTION

The problems noted above are solved in large part by a computer rack system which may include a plurality of chassis of servers and power supplies and other equipment, as desired, mated to the rack. Each server chassis can accommodate a plurality of servers and each power supply chassis accommodates a plurality of power supplies. The various servers and power supplies located in a chassis couple to a chassis communication module and the various chassis couple together via the chassis communication modules.

Each server is initially configured when installed into the rack. When a server is activated, logic in the server determines whether the server has been configured. If the server has not been configured, the server submits a request to its chassis communication module. The request includes an indication as to the type of server being configured. The chassis communication module then determines whether another server in that chassis or another chassis has been configured and is identical or similar enough to the server to be configured (using the server type in the configuration request) that such other server's configuration data can be used to configure the server being configured. If such a server exists, that server's configuration data is provided to the server being configured. Such configuration data may obtained from the previously configured server or reside in a chassis communication module connected to the previously configured server.

An operator can use a workstation coupled to the rack to specify how the automatic configuration process is to behave. For example, the operator can manually configure one server in a rack and direct the system to use that server's configuration data when automatically configuring all other servers in the same rack. Multiple racks can be coupled together via the chassis communication modules thereby permitting configuration data for a server in one rack to be used to configure servers in a different.

These and other features and benefits will be described below in reference to the drawings.

### BRIEF DESCRIPTION OF THE DRAWINGS

For a detailed description of the preferred embodiments of the invention, reference will now be made to the accompanying drawings in which:

FIG. 1 shows a rack mounted computer system including a plurality of automatically configurable servers coupled to chassis communication modules;

FIG. 2 shows a block diagram of a server;

FIG. 3 shows a communication module in accordance with the preferred embodiment; and

FIG. 4 shows the system of FIG. 1 indicating the location of configuration data to be used to automatically configure a server.

### Notation and Nomenclature

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections. Further, as is commonly understood, processors execute firmware or software code. One type of firmware code is referred to as the “system ROM.” It is thus common to refer to the system ROM as performing certain functions, when in fact, technically, it is the processor that executes executable instructions stored on the system ROM that performs the functions.

### DETAILED DESCRIPTION OF THE PREFERRED EMBODIMENTS

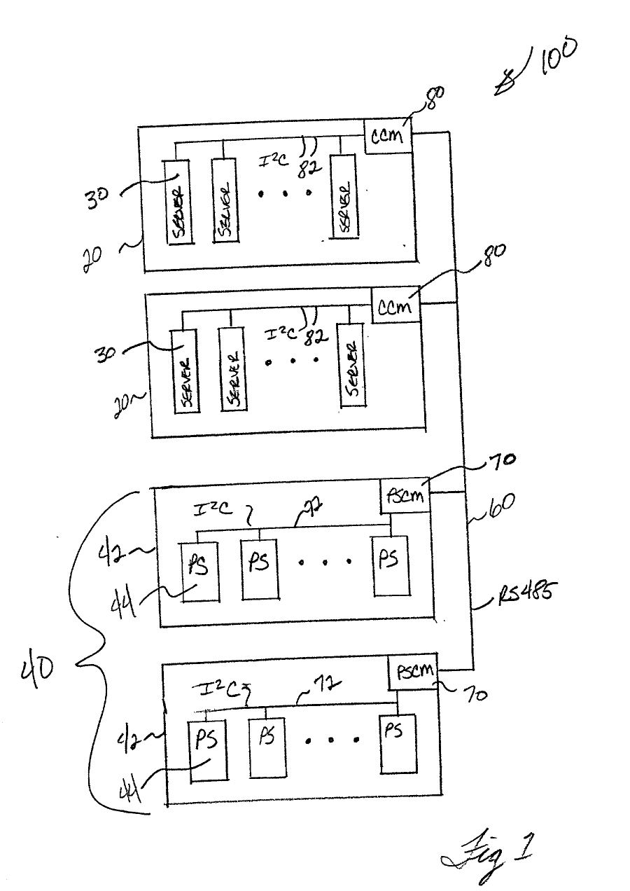

FIG. 1 shows an implementation of a rack mounted server system 100 constructed in accordance with a preferred embodiment of the invention. As shown, system 100 includes a plurality of chassis 20, each chassis adapted to receive a plurality of servers 30 therein. Further, FIG. 1 shows a power supply system 40 comprising two power supply chassis 42. Each power supply chassis 42 preferably houses a plurality of individual power supplies 44. Severs 30 and power supplies 44 preferably are made with blind mating connectors so that they can readily be removed and inserted into the chassis.

Each chassis 20 preferably has associated therewith a chassis communication module 80. The chassis communication module 80 in each chassis 20 couples to each individual server 30 across a serial communication bus 82, which in the preferred embodiment is an I²C bus. The I²C bus 82 is a dual line, multidrop serial bus developed by Phillips Semiconductor that comprises a clock line and one data line. The devices connected to the I²C bus can act as either primary or secondary devices, and each device is software addressable by a unique address. Primary devices can operate as transmitters, receivers, or combination transmitter/receivers to initiate eight-bit data transfers between devices on the bus. The I²C bus utilizes collision detection and arbitration to prevent data corruption if two or more primaries simultaneously transfer data. Details regarding the I²C bus may be found in “The I²C-Bus Specification,” version 2.1 (January 2000), authored by Phillips Semiconductors.

Each chassis communication module 80 preferably communicates with the servers 30 in its associated chassis 20 over the I²C bus 82. The chassis communication modules 80 also preferably couple to the power supply communication modules 70 in the power supply system 40. The chassis communication modules 80 and the power supply communication modules 70 preferably couple by way of a serial communication pathway 60 being, in accordance with the preferred embodiment of the invention, an Institute of Electrical and Electronic Engineers (“IEEE”) RS-485 bus.

Much like the chassis communication module 80, each power supply communication module preferably couples to a plurality of devices in its associated power supply chassis 42. In particular, the power supply communication module 70 couples to each individual power supply 44 in its associated power supply chassis 42 over an I²C serial bus 72. The power supply communication module may monitor various parameters associated with the individual power supplies 44 including, for example, the power output of each individual power supply 44. By polling each individual power supply 44 across the I²C bus 72, each power supply communication module 70 may make a determination as to remaining power capacity, if any, in its respective power supply chassis 42. FIG. 1 shows two power supply chassis 42, and two power supply communication modules 70. Preferably each of these power supply communication modules 70 has the ability to monitor parameters of the individual power supplies 44 within its respective power supply assembly 42. Preferably, however, only one of the power supply communication modules 70 is designated as the primary power supply communication module, which makes that primary power supply communication module responsible for communicating on behalf of the entire power supply system 40.

Referring still to FIG. 1, the chassis communication modules 80 transmit requests for allocation of power to the primary power supply communication module 70 over the serial communication pathway 60. Likewise, the primary power supply communication module 70 responds to those requests by sending messages across the serial communication pathway 60 to the requesting server 30, by way of its respective chassis communication module 80.

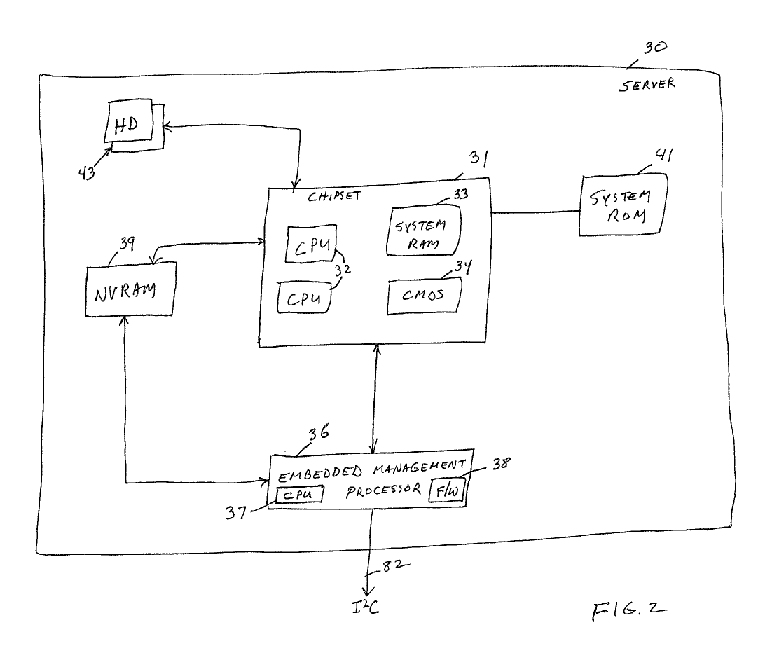

Referring now to FIG. 2, a block a diagram of a server 30 is shown in accordance with the preferred embodiment. A variety of different architectures and devices can be provided—the architecture of FIG. 2 represents only one such exemplary architecture. As shown, the server includes a chip set 31, an embedded management processor 36, a non-volatile random access memory (“NVRAM”) 39, a system read only memory (“ROM”) 41 and one or more hard disk drives 43. The chipset 31 preferably includes one or more central processing units (“CPUs”) 32, system random access memory (“RAM”) 33 and complementary metal oxide semiconductor memory (“CMOS”) 34. As will be explained below, the NVRAM 39 and CMOS memory 34 store configuration data for the server 30. The capacity of NVRAM 39 may be any desired capacity, such as 4 kilobytes, while the capacity of CMOS memory 34 may be smaller (e.g., 64 bytes). System RAM 33 preferably is used to store instructions to be executed by the CPU(s) 32 as well as a temporary location to store data and other types of information. The system ROM 41 stores instructions executable by the CPU(s) 32 to perform various low level type of activities such as initialization and input/output functions. Application software and other types of information preferably are stored on the hard disk drive(s) 43 and are accessed by the chipset 31.

The embedded management processor 36 preferably includes a CPU 37 and nonvolatile memory 38 containing firmware executed by CPU 37. The chipset 31 and the embedded management processor 36 both couple to the NVRAM 39 and both can access (read and write) the NVRAM 39. The embedded management processor 36 provides a number of functions. Of particular interest to the preferred embodiment, as explained below, the embedded management processor coordinates the allocation of power to the server 30 as well as its initial configuration.

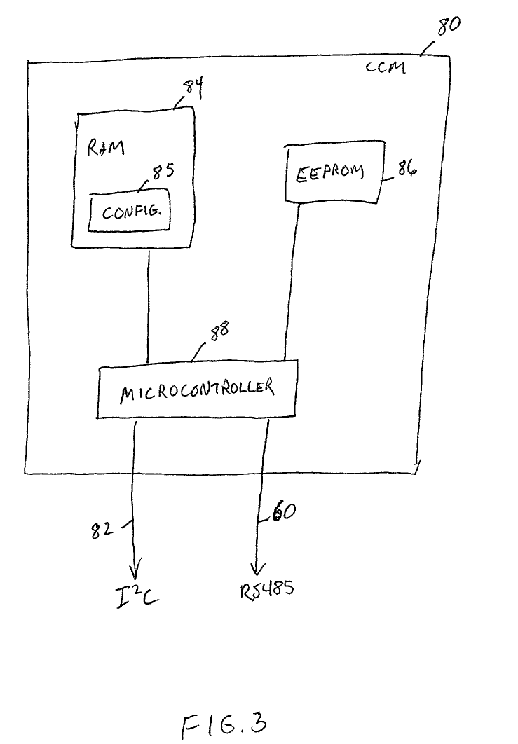

FIG. 3 shows a block diagram of a chassis communication module 80 in accordance with the preferred embodiment. In particular, FIG. 3 shows that the chassis communication module 80 comprises a microcontroller 88. The chassis communication module 80 also preferably includes RAM memory 84 and an electrically erasable programmable read only memory (“EEPROM”) 86 coupled to the microcontroller. The RAM 84 is preferably working space for executing programs by the microcontroller. The RAM 84 preferably also includes the ability to store server configuration data 85 for one or more servers. The EEPROM 86 preferably stores firmware programs that when executed by the microcontroller 88 perform the various functions required of the chassis communication module 80. FIG. 3 also shows that the microcontroller 82 of the chassis communication module 80 preferably couples to the I²C bus 82 and the RS-485 bus 60. For purposes of this disclosure, each power supply communication module 70 has substantially the same components as a chassis communication module 80. Thus, FIG. 3 showing the microcontroller 88, RAM 84 and EEPROM 86 for the chassis communication module 80 is equally applicable to the power supply communication module 70.

The following discussion explains how a server 30 can be inserted and automatically configured by the system 100 without requiring extensive operator involvement such as is required by conventional configuration techniques. It should be understood, however, that the following principles can readily by applied to any type of electrical, configurable device that is installed in a system having other such devices. For example, to the extent that the power supplies 44 require configuration, the preferred embodiment described below can be applied to the power supplies as well as the servers. Other types of configurable devices are within the scope of this disclosure, such as storage devices, network switches, and the like.

Each server 30 preferably is configured upon installation before it begins normal operations. The configuration of a server preferably involves specifying a number of parameters and/or data. The aggregate of all types of configuration information is referred to for purposes of this disclosure as “configuration data.” The configuration data may include values such as the time and date, whether a power on password security feature has been enabled, the language used for output text and network messages, etc. The configuration data stored on a server preferably is stored in memory, such as in NVRAM 39 and/or CMOS memory 34, and the type of memory device(s) in which the configuration data is stored is not important. In accordance with the preferred embodiment, most of the configuration data is stored in NVRAM 39 and a few items of configuration data (e.g., time and date) are stored in CMOS memory 34.

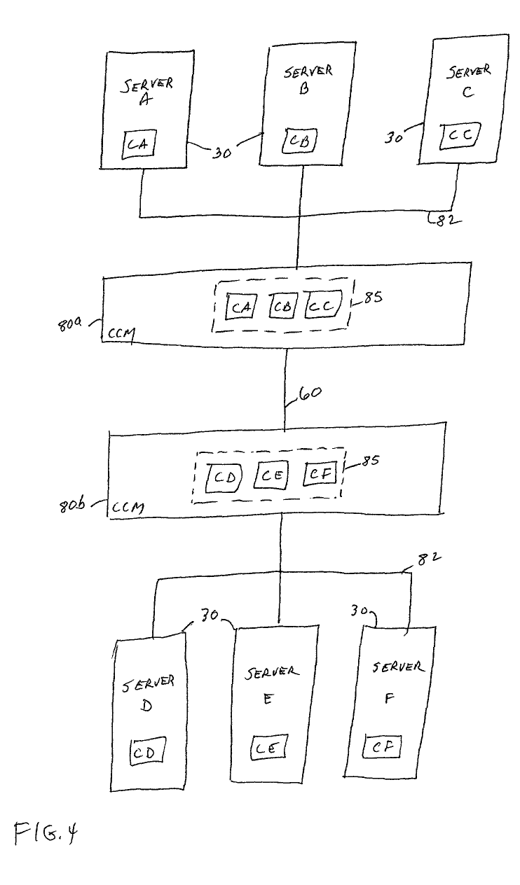

In accordance with the preferred embodiment of the invention, each server 30 can be configured automatically using configuration data stored in a location other than on the server itself. Any one of a variety of implementations for this principle are acceptable. For example, RAM 84 in the CCM 80 (FIG. 3) may include storage allocation 85 for configuration data for the servers. Alternatively, configuration data to be used for a server may be obtained from the configuration data stored on a different server. These principles will be illustrated using the system diagram of FIG. 4.

Referring now to FIG. 4, three servers A, B and C are shown coupled to a CCM 80a. Servers D, E, and F are also shown coupled to their own CCM 80b. The two CCMs are coupled together and in communication with each other via bus 60. Once fully configured, each server A-F includes its own configuration data preferably stored, as noted above, in NVRAM 39 and CMOS 34. The configuration data for each server is shown in FIG. 4 as CA-CF. Preferably, a copy of each of the configuration data sets CA-CF is maintained on the CCMs 80 in memory 85 as well as on the servers themselves (e.g., in CMOS memory 34 and/or NVRAM 39). In this way, the configuration data set of one server readily can be accessed for use by another server as discussed below.

The configuration process for server C will now be considered to illustrate how a newly installed server can automatically be configured. Before the server can be configured, it first must be powered up. Briefly, the power supply system 40 provides a minimal level of power to the slot occupied by the server. Preferably, there is at least enough power to activate and power the embedded management processor 36 in the server. Once the embedded management processor 36 initializes, in accordance with its own firmware 38, the embedded management processor 36 begins a handshaking process with the CCM 80 connected to that server. The handshaking process is intended to ensure that both the embedded management processor 36 and the CCM 80 are operational before the configuration process begins. After this handshaking procedure, the embedded management processor 36 submits a request through the CCM 80 to the power supply system 40 to provide the server enough power for full operation. If sufficient power is available, the power supply system 40 allocates sufficient power to the newly installed server.

When server C is physically inserted into the rack, the server may not have any configuration data or at least not have sufficient configuration data to be capable of normal operation. Accordingly, configuration data CC for newly installed server C will not exist in CCM 80a. The server's system ROM 41 detects the lack of configuration in accordance with any one of a variety of techniques. For example, the system ROM may examine the NVRAM 39 and/or CMOS memory 34 for a certain string of values (e.g., zero values) that indicates an unconfigured server.

Once the system ROM 41 detects that server C has not yet been configured, the system ROM preferably submits a request to the embedded management processor 36 to obtain suitable configuration data for use by the server. The embedded management processor 36 forwards the request over bus 82 to the CCM 80a connected to server C. The embedded management processor 36 also is programmed or hard wired for the type of server C. server types can include anything desired for identifying various classes of devices, such as a one processor server, two processor server, four processor server, etc. Server types may correspond to models of servers or may correspond to the function performed by the server such as a web page server. The type of server that comprises server C is included in the request for configuration data provided by server C to CCM 80a. CCM 80a responds to server C's request for configuration by determining whether any of its other configuration data sets CA or CB stored in memory 85 can be used for server C. Typically, at least two of the servers inserted into a chassis 20 are of the same type, and often all of the servers in the same chassis are of the same type and can share configuration data.

If other servers reside in the same chassis 20 as server C (the server being configured), then the configuration data for such other servers will already be stored on CCM 80a. If any of the configuration data sets already stored in CCM 80a can be used to configure newly installed server C (i.e., configuration data of servers for which server C can be configured the same), then the CCM 80a provides one of such configuration data sets to server C. Once the configuration data set is provided to server C, the server's chipset may parse the data set and store its various parameters in NVRAM 39 and/or CMOS memory 34. Alternatively, the embedded management processor 36, which also has access to NVRAM 39, can store configuration parameters from the configuration data set directly into NVRAM 39 without assistance from the chipset. If the embedded management processor 36 cannot directly access the CMOS memory 34 and configuration data is to be stored therein, the embedded management processor 36 provides such data to the chipset 31 for storage in the CMOS memory by the CPU(s) 32.

Thus, the system automatically uses configuration data corresponding to a server identical or similar to newly installed server C. This automatic configuration process alleviates an operator from having to manually configure server C, and all servers for that matter. Instead, the operator preferably manually configures at least one server and that configuration data can be used to configure other servers. The operator could install and manually configure on server in a chassis and permit all other subsequently installed servers to go through the automatic configuration process.

There are numerous variations and possibilities for the automatic configuration technique explained above. For example, rather than using a configuration data set stored on the CCM 80, a configuration data set physically stored on another server can be used. Thus, the configuration data (CB) stored on server B itself can be copied to server C for configuring server B. In this case, the CCM 80a preferably coordinates the transfer of the configuration data CB from server B through the CCM 80a to server C.

Further still, it may be that none of the other servers in the same chassis with server C (assuming there are other servers in the chassis) are of a type that permits their configuration data to be used for server C. In the event that none of the configuration data sets corresponding to servers in the same chassis can be used, the CCM (CCM 80a in the case of configuring server C) may forward server C's configuration request to other CCMs, such as CCM 80b. The configuration request forwarded on to CCM 80b identifies the type of server for server C. If CCM 80b determines that any of configuration data sets stored in CCM 80b (i.e., CD-CF) can be used by a server of the type of server C, then CCM 80b forwards a copy of such suitable configuration data set to CCM 80a which, in turn, forwards it on to server C. If desired, the configuration data for servers D-F can be taken directly from the servers D-F themselves, rather than from CCM 80b. being able to locate and transmit configuration data between CCMs permits an operator to manually configure one server in a rack and use that server's configuration to configure all other servers in the same rack, even servers connected to different CCMs (assuming the operator wishes to identically configure all servers in a rack). Thus, if a rack includes 24 servers, for example, the operator can manually configure one server and the remaining 23 servers can automatically configure themselves based on the manually configured server's configuration. Further still, multiple racks of servers can be coupled together via the CCMs and the configuration for a server in one rack can be used in the automatic configuration process for a server in a different rack.

Once a server is configured, a copy of its configuration data is maintained on its corresponding CCM 80. Thus, once server C is configured, a copy of its configuration data (CC) is stored on CCM 80a. That copy of the configuration data may be copied to the CCM by the newly configured server, or it can be kept on the CCM 80 when the CCM initially forwards the configuration data to the server.

It should be noted that the embodiments described herein are also useful when replacing a server, not just installing a new server into a slot that was previously unoccupied. For example, if server C is fully configured and operational, a copy of its configuration data (CC) is kept on the CCM 80 as noted above. If server C then malfunctions, it can be removed and replaced with another server. The newly inserted server can then automatically be configured using the configuration data CC stored on the CCM. The user need not manually configure the newly replaced server CC and the server automatically can be configured with exactly the same data as was used to configure the old server CC that was removed from the system.

If a server is replaced with a server of a different type or an upgraded server, such newly installed server can be provided with configuration data of a different server, rather than the configuration data that was used for the old server. Thus, if server C is replaced with an upgraded model that is the same as server A, newly installed server C can be configured with the configuration data (CA) corresponding to server A, rather than the configuration data (CC) corresponding to previous server C.

As should be apparent, there are numerous possibilities for how the system 100 can behave when configuring a configurable device. In accordance with a preferred embodiment of the invention, a management workstation (not shown) can be coupled to system 100 to direct the CCMs how to perform to provide the desired automatic configuration process described herein. That is, the CCMs can be programmed on a server-by-server basis how the CCMs are to configure each server when installed. For example, by using the workstation, the operator can specify that the CCMs are to use the configuration data for server A when configuring all other servers. A workstation can also be used to specify whether for a given server type or server slot location in the rack whether that server is to be automatically configured or be manually configured by a human being.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An automatic method of configuring a server in a system including a plurality of servers, comprising:
(a) requesting configuration data by the server to be configured;
(b) automatically retrieving configuration data appropriate for the server from a device external to the server; and
(c) providing the retrieved configuration data to the server.

2. The method of claim 1 wherein said external device comprises a chassis communication module.

3. The method of claim 1 wherein the server and other servers couple to a chassis communication module and (b) includes retrieving the configuration data from another server besides said server being configured.

4. The method of claim 1 further including determining which of said other servers includes configuration data suitable for use by the server being configured and (b) includes retrieving such other server's configuration data.

5. The method of claim 1 wherein (a) includes providing a server type value with said request for configuration data.

6. The method of claim 5 further including using said server type value to determine which of said other servers includes configuration data suitable for use by the server being configured and (b) includes retrieving such other server's configuration data.

7. A computer system, comprising:
a first plurality of servers; and
a first chassis communication module coupled to said first plurality of servers;
wherein at least one of said plurality of servers can be configured automatically once installed into said system, said installed server to be configured submitting a request for configuration data to said first chassis communication module which automatically retrieves and provides configuration data to said server for configuration.

8. The computer system of claim 7 wherein said configuration data provided to said server was stored in memory on said first chassis communication module.

9. The computer system of claim 7 wherein said configuration data provided to said server was stored on another of said plurality of servers.

10. The computer system of claim 7 further including:
a second chassis communication module coupled to said first chassis communication module; and
a second plurality of servers coupled to said second chassis communication module;
wherein said configuration data provided to said server was stored in memory on said second chassis communication module.

11. The computer system of claim 7 further including:
a second chassis communication module coupled to said first chassis communication module; and
a second plurality of servers coupled to said second chassis communication module;
wherein said configuration data provided to said server was stored in memory on one of said second plurality of servers.

12. The computer system of claim 7 wherein said request includes the type of server to be configured and said first chassis communication module uses said type of server to retrieve configuration data suitable for the server to be configured.

13. The computer system of claim 12 wherein said first chassis communication module finds another of said first plurality of servers that is of the same type as the server to be configured and retrieves configuration data corresponding to such matching other server.

14. An electronic system, comprising:
a first plurality of configurable devices; and
a first chassis communication module coupled to said first plurality of configurable devices;
wherein at least one of said plurality of configurable devices can be configured automatically once installed into said system, said installed configurable device to be configured submitting a request for configuration data to said first chassis communication module which retrieves and provides configuration data to said configurable device for configuration.

15. The electronic system of claim 14 wherein said configuration data provided to said server was stored in memory on said first chassis communication module.

16. The electronic system of claim 14 wherein said configuration data provided to said server was stored on another of said plurality of servers.

17. The electronic system of claim 14 further including:
a second chassis communication module coupled to said first chassis communication module; and
a second plurality of servers coupled to said second chassis communication module;
wherein said configuration data provided to said server was stored in memory on said second chassis communication module.

18. The electronic system of claim 14 further including:
a second chassis communication module coupled to said first chassis communication module; and
a second plurality of servers coupled to said second chassis communication module;
wherein said configuration data provided to said server was stored in memory on one of said second plurality of servers.

19. The electronic system of claim 14 wherein said request includes the type of server to be configured and said first chassis communication module uses said type of server to retrieve configuration data suitable for the server to be configured.

20. The electronic system of claim 19 wherein said first chassis communication module finds another of said first plurality of servers that is of the same type as the server to be configured and retrieves configuration data corresponding to such matching other server.

21. A configurable device adapted to be installed into a system that includes other configurable devices, said configurable device including:
a CPU;
memory coupled to said CPU and on which configuration is stored; and
an embedded management processor coupled to said CPU, said embedded management processor determines whether said configurable device has been configured and, if not, submits a request to an external device to provide configuration data corresponding to another configurable device in said system.

22. The configurable device of claim 21 wherein said request includes a configurable device type.

23. A method of configuring a server in a system including a plurality of servers, comprising:
(a) requesting configuration data by the server to be configured;
(b) if automatic configuration has been specified for the server, automatically retrieving configuration data appropriate for the server from a device external to the server; and providing the retrieved configuration data to the server; or
(c) if automatic configuration has not been specified for the server, manually configuring the server.
